(19) United States
(12) Patent Application Publication
(10) Pub. No.: US 2012/0007557 A1
(43) Pub. Date: Jan. 12, 2012

(54) Motive Power Dual Battery Pack

(75) Inventor: Larry Hayashigawa, Orange, CA (US)

(73) Assignee: AeroVironment, Inc., Monrovia, CA (US)

(21) Appl. No.: 13/236,553

(22) Filed: Sep. 19, 2011

Related U.S. Application Data
(63) Continuation of application No. 12/561,975, filed on Sep. 17, 2009, now abandoned.
Application No. 12/561,975 is a continuation of application No. 11/591,667, filed on Oct. 31, 2006, now abandoned.
(60) Provisional application No. 60/732,604, filed on Nov. 1, 2005.

(51) Int. Cl. H02J 7/00

(52) U.S. Cl. 320/117

(57) ABSTRACT

A fast charge configuration for a power supply includes a serial connection to a pair of batteries each having an output that is half that required by the device, such as the electric vehicle, in which the batteries are to be used. When the batteries in then connected to the vehicle, they are connected in parallel

### CROSS-REFERENCE TO RELATE APPLICATIONS

This application is a continuation of U.S. patent application Ser. No. 12/561,975, entitled “Motive Power Dual Battery Pack,” filed on Sep. 17, 2009, which is a continuation of U.S. patent application Ser. No. 11/591,667, entitled “Motive Power Dual Battery Pack,” filed on Oct. 31, 2006, and claims the benefit of U.S. provisional patent application no. 60/732,504, entitled “Motive Power Dual Battery Pack,” filed on Nov. 1, 2005.

### BACKGROUND OF THE INVENTION

1. Field of the Invention

The present invention relates to electric vehicles. More specifically, the present invention relates to adapting electric vehicles for fast charging technology.

2. Description of the Related Art

Recreational and industrial vehicles are prevalent in today's world. Examples include golf carts, forklifts, and airport transport and luggage handling carts. Because electric vehicles create less pollution than internal combustion (i.e., gasoline and diesel powered) vehicles, they are an environmentally friendly, and increasingly acceptable, alternative.

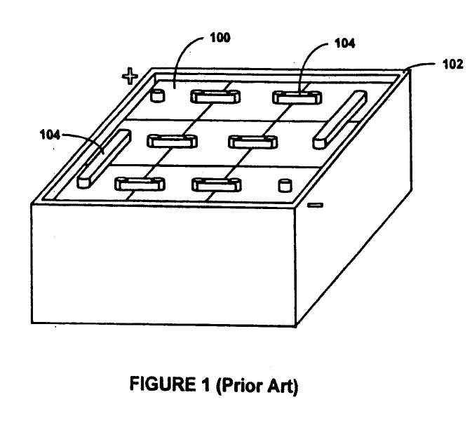

As shown in FIG. 1, electric vehicles are typically powered by a battery pack comprised of a plurality of rechargeable batteries (or “cells”) 100. The battery pack cells 100 are housed in a battery pack case (or “tray”) 102. The cells 100 are usually connected in series by way of electrical connectors 104. The battery pack case 102 is typically semi-permanently mounted on or inside the electric vehicle. The battery pack is typically made up of a multiplicity of two-volt batteries connected in series. For a 24 volt battery pack, twelve two-volt batteries are used. For a 36 V battery pack, 18 two-volt batteries are used, and for a 48 V battery pack, 24 two-volt batteries are used.

A necessary operational aspect of electric vehicles is the periodic recharging of the battery pack. In some applications the battery pack may be recharged without having to remove the battery pack from the vehicle. However, in other applications the depleted battery pack must be removed and replaced with a fully charged replacement battery pack. In factory operations, for example, the electric vehicles (typically forklifts) are powered by high-capacity batteries. High-capacity batteries have amp-hour ratings of 1000 Amp-hrs or more, and require six to eight hours of charging to restore the battery to full charge. Hence, to avoid rendering the vehicle unavailable for use during the six to eight hours needed to recharge the depleted battery pack, the depleted battery pack is typically lifted out of the vehicle and replaced with a fully charged replacement pack. Because the battery packs can weigh up to 4,000 lbs, special hydraulically powered lift machines are used to complete the battery pack swapping operation.

In recent years, engineers have developed what is known as “fast charging” technology. Fast charging reduces the recharge time of a 1000 Amp-hr battery, from the typical six to eight hours required using conventional battery charging techniques, to about an hour. Fast charging thereby allows recharging to be performed, for example, during an operator's lunch break, or during other opportune times when the vehicle may not be needed. For this reason, fast charging technology is sometimes referred to as “opportunity charging”. Fast charging also eliminates the need to repeatedly swap out and replace depleted battery packs with charged battery packs.

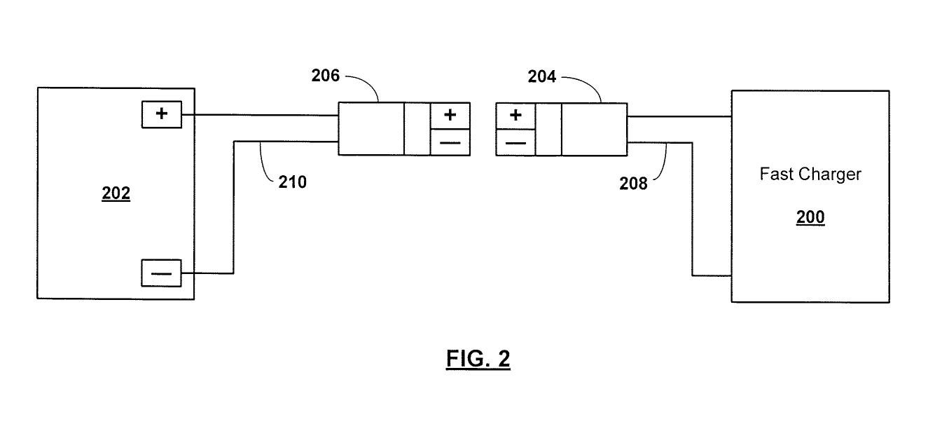

A conventional fast charge charging configuration is shown in FIG. 2, in which a fast charger 200 is connected to battery pack 202 containing series-connected batteries (not shown) by way of connectors 204, 206 and cables 208 and 210. Battery pack 202 is a 48 V battery pack. Fast charger 200 is a 48 nominal charge device delivering 360 amp-hours of current.

With conventional charging and battery changing, charging currents were well below the ratings of the cables and interconnects being used on the batteries. In fact, it was the vehicle power demand that determined the battery interconnect and cable sizing, rather than the charger. With the advent of fast charging, however, the charger has become the driver of battery inter-cell connection size and the capacity of the cables used for battery charging. In other words, the very large currents involved in fast charging have demanded very robust equipment, including large capacity cables that are heavy and expensive.

Table 1 below shows the charge conditions for standard 36-V and 48-V battery packs used in motive power applications. The fast charge currents required for these batteries are very high, which in turn places a high demand on related power electronics and electronic component within the charger driving costs up. In addition, batteries need to be modified to accept these higher currents.

TABLE I

| | Nom. Charge | Capacity | Energy | | Charge |
|---|---|---|---|---|---|
| Vbattery | Voltage | amp-hr | watt-hrs | C rate | Current |
| 36 | 36 | 1200 | 43200 | 0.4 | 480 A-hrs |
| 48 | 48 | 900 | 43200 | 0.4 | 360 Amp-hrs |

The vast majority of high energy motive batteries are either 36V or 48V, which from the vehicle demand side is acceptable because average currents do not exceed 250 amps. However, with fast charging, currents may need to be twice as high during the charge process. These higher currents drive up battery and charger costs and energy efficiency down.

### BRIEF SUMMARY OF THE INVENTION

A method for charging and discharging a battery-based power supply of an electric vehicle includes charging a plurality of batteries using a series connection to a fast charger, and discharging the plurality of batteries using a parallel connection to the electric vehicle.

A further method for providing an electric vehicle with power at a first voltage includes simultaneously fast charging a pair of batteries each rated at a voltage output that is half said voltage requirement, and connecting said pair of batteries to the electric vehicle.

A system for charging and discharging a battery-based power supply of an electric vehicle includes means for charging a plurality of batteries using a series connection to a fast charger, and means for discharging the plurality of batteries using a parallel connection to the electric vehicle.

A further system for providing an electric vehicle with power at a first voltage includes means for simultaneously fast charging a pair of batteries each rated at a voltage output that is half said voltage requirement, and means for connecting said pair of batteries to the electric vehicle.

Many advantages of the present invention will be apparent to those skilled in the art with a reading of this specification in conjunction with the attached drawings, wherein like reference numerals are applied to like elements, and wherein:

FIG. 1 is a perspective view of battery pack for an electric vehicle;

FIG. 2 is a schematic view of a conventional fast charge set-up;

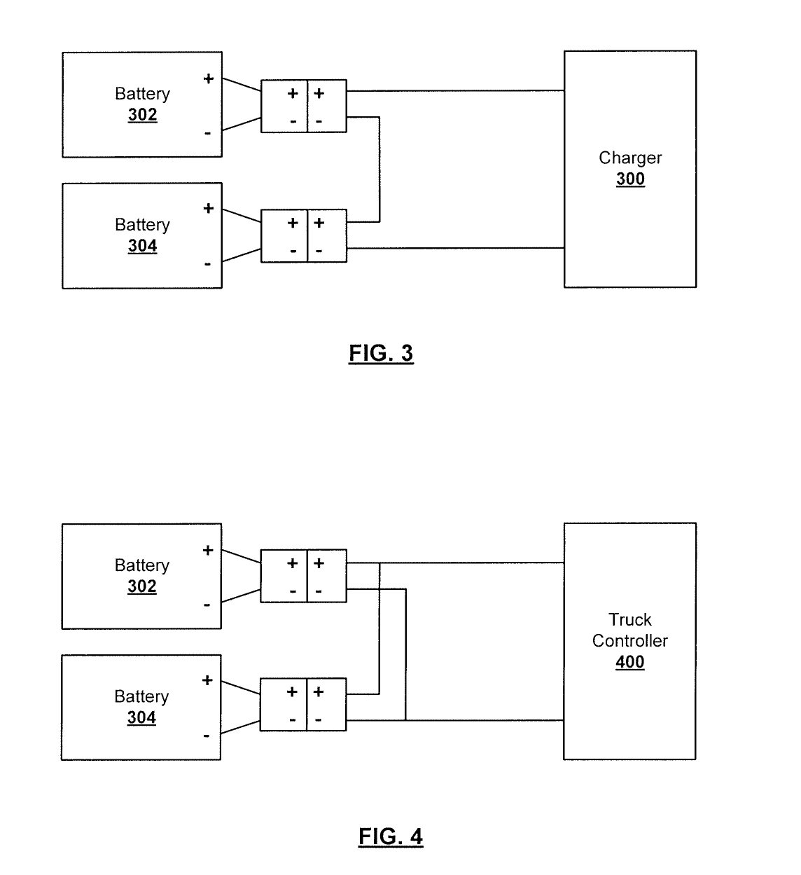

FIG. 3 is a schematic view of a fast charge set-up in which batteries are connected in series to a fast charger; and

FIG. 4 is a schematic view of a discharge set-up in which batteries are connected in parallel to a vehicle controller.

### DETAILED DESCRIPTION OF THE INVENTION

Embodiments of the present invention are described herein in the context of motive power dual battery pack. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

According to an aspect of the invention, rather than use a single, large amp-hour battery pack comprised either of 12, 18 or 24 two-volt cells (to achieve 24, 36 or 48 V output), two smaller amp-hour capacity battery packs are used. These consequently involve a smaller current draw during charging, and particularly, during fast charging. For example, the two smaller battery packs could be one half the capacity of a standard battery pack. Wiring for the fast charger would be such that when connected to the batteries it would charge the two batteries in series. Then, when in use in the vehicle, wiring for the vehicle would be such that when the battery pack is connected to the vehicle it would be connected in parallel. The advantage for such a configuration can be seen from Table II below, which shows exemplary charge conditions for two smaller amp-hour battery packs.

TABLE II

| | Nom. Charge | Capacity | Energy | | Charge |
|---|---|---|---|---|---|
| Vbattery | Voltage | amp-hr | watt-hrs | C rate | Current |
| 36 | 72 | 1200 | 43200 | 0.4 | 240 Amp-hrs |
| | | | | | charge two |
| | | | | | smaller 36 V |
| | | | | | batteries |
| 48 | 96 | 900 | 43200 | 0.4 | 180 Amp-hrs |
| | | | | | charge two |
| | | | | | smaller 48 V |
| | | | | | batteries |

As suggested by the 48 V entry, the current draw in this case is reduced to 180 amp-hours by the use of two battery packs connected in series during fast charge. FIG. 3 illustrates this configuration, and shows a 96 V fast charger 300 connected to a pair of battery packs 302, 304 in series. The battery packs are each a 24 V component, and the fast charging process has a current draw of 180 amp-hours, which is half the conventional draw (360 amp-hours, Table I).

As seen in FIG. 4, during discharging operation—that is, when providing power to a vehicle controller 400 for driving a vehicle and possibly powering other components thereof, the battery packs 302, 304 are connected in parallel to the controller to thereby operate as a 48 V power supply. It will be appreciated that while described in terms of two batteries that have an output rating that is ½ of the total output utilized by the vehicle during operation, a more generalized application would use N batteries each rated to provide 1/N of the power required by the vehicle.

By charging two smaller amp-hour battery packs in series, some existing chargers can charge at twice the power. For example, some chargers used to charge 36-V and 48-V battery packs, at a maximum allowable current of 250 A set by the battery pack, have the capability of charging 72-V and 96-V battery packs at the same 250 A. Thus existing fast charges can be utilized, and in many applications, no modifications to the charger are required. This significantly reduces fast charge throughput. Further, 4X lighter charger cable can be used, which is of lower cost as cable is made of 2 ea 2/0 cable and not 4 ea 4/0 cable. Further, the use of two standard batteries means no double cell interconnects or 4/0 cable. It relies on simple to implement cabling, requiring no significant change to the charging process, but requires two connectors. It can be retrofitted into existing applications as the cost of a new battery, and there is no need for a higher output charger. Further, heat generation can be up to 20% less. It provides a redundant battery system, and uses a lighter charger cable to charge large batteries—for example, a single Euro-connector and 2/0 cables. In addition, the connections for charging and/or discharging could be incorporated into an integrated battery system such as that described in U.S. patent application Ser. No. 11/186,730.

The above are exemplary modes of carrying out the invention and are not intended to be limiting. It will be apparent to those of ordinary skill in the art that modifications thereto can be made without departure from the spirit and scope of the invention as set forth in the following claims.

1. A method for charging and discharging a battery-based power supply of an electric vehicle, comprising:
charging a plurality of batteries, each having a corresponding connector, using a series connection to a fast charger, the series connection including a charger connector coupled to each battery connector; and
discharging the plurality of batteries using a parallel connection to the electric vehicle.

2. The method of claim 1, wherein the plurality of batteries comprises two batteries.

3. The method of claim 1, wherein the plurality of batteries comprises N batteries each rated to provide an output of 1/N of the total power required by the electric vehicle.

4. A method for providing an electric vehicle with power at a first voltage, comprising:
simultaneously fast charging a pair of batteries each rated at a voltage output that is half said voltage requirement, each battery of said pair having a corresponding connector, said charging being conducted by way of a connection that includes a charger connector coupled to each battery connector; and
connecting said pair of batteries to the electric vehicle.

5. The method of claim 4, wherein said fast charging includes connecting the pair of batteries to fast charger in a series connection

6. The method of claim 4, wherein said pair of batteries are connected to the electric vehicle in parallel.

7. A system for charging and discharging a battery-based power supply of an electric vehicle, comprising:
means for charging a plurality of batteries, each having a corresponding connector, using a series connection to a fast charger, the series connection including a charger connector coupled to each battery connector; and
means for discharging the plurality of batteries using a parallel connection to the electric vehicle.

8. A system for providing an electric vehicle with power at a first voltage, comprising:
means for simultaneously fast charging a pair of batteries each rated at a voltage output that is half said voltage requirement, each battery of said pair having a corresponding connector, said charging being conducted by way of a connection that includes a charger connector coupled to each battery connector; and
means for connecting said pair of batteries to the electric vehicle.
